(19) United States
(12) Patent Application Publication
(10) Pub. No.: US 2014/0053736 A1
(43) Pub. Date: Feb. 27, 2014

(54) SINGLE SERVING BEVERAGE INFUSER AND METHOD OF PRETREATING THE SAME

(71) Applicants: Larissa Simontov, Seattle, WA (US); Slava Simontov, Seattle, WA (US)

(72) Inventors: Larissa Simontov, Seattle, WA (US); Slava Simontov, Seattle, WA (US)

(21) Appl. No.: 13/592,341

(22) Filed: Aug. 23, 2012

(51) Int. Cl. A47J 31/20; B08B 9/08

(52) U.S. Cl. 99/323; 134/22.1

(57) ABSTRACT

A single serving beverage infuser and method of pretreating the same is disclosed herein. In one embodiment, the beverage infuser comprises a receptacle for receiving a charge of beverage infusing material and a tether attached to a top end of the receptacle for suspending the receptacle, the tether being configured such that at least a portion of the tether is capable of hooking onto at least a portion of a beverage container wherein a beverage is to be infused. Preferably, the infuser is made from natural bamboo fibers and, accordingly, the method of pretreating the beverage infuser removes the undesirable woody and bitter taste present in the bamboo fibers.

### FIELD

A single serving beverage infuser and method of pretreating the same is disclosed herein.

### BACKGROUND

In recent years, there has been an increase in the interest in and consumption of infused beverages, such as teas, in the United States. There has also been an increased demand for means of producing single servings of infused beverages. Generally, a single serving of an infused beverage is produced by utilizing at least one of a type of strainer or a standard disposable tea bag.

One type of strainer that is commonly used for producing single servings of an infused beverage comprises a well portion for receiving a charge of infusing material, such as tea leaves, and is placed over the opening of a beverage container. The specific type of strainer described in this paragraph is depicted in FIG. 5. In order to infuse the desired beverage the well portion is either submerged into hot water already in the beverage container or hot water is poured through the charge of infusing material and allowed to strain into the beverage container. Such strainers are commonly made from natural bamboo fibers, plastics, or from various metals. Typically, this type of strainer comprises a single handle and, therefore, while a beverage is being infused, a user must hold the strainer in such a position that the charge of infusing material remains in contact with the hot water. This type of strainer has the drawback of being relatively awkward and inefficient from a process standpoint. Many beverage consumers prefer to place the charge of infusing material in contact with the hot water without manually holding the strainer in this position; however, this type of strainer is ill-suited to perform this task. Also, in order to optimally meet an individual beverage consumer's taste preferences, many consumers prefer to taste a beverage throughout the infusing process in order to stop the infusing process once the desired strength or flavor has been reached. This type of strainer typically covers a large portion of the beverage container opening and must be removed, which causes the strainer to drip, at each of many time intervals when a user chooses to taste the beverage. Therefore, a single serving beverage infuser that is self-supporting during the infusing process and which does not require the removal thereof to facilitate tasting of the beverage is desirable.

While some strainers address the disadvantage of having to manually hold the strainer by providing a means for resting the strainer over the beverage container opening, such strainers do not alleviate undesirable blockage of the beverage container opening. The specific type of strainer described in this paragraph is depicted in FIG. 6. Accordingly, in order to optimally meet an individual beverage consumer's taste preferences, these strainers must still be repeatedly removed and replaced during the infusing process, the result being undesirable dripping as was previously described. Additionally, because these strainers are not adjustable the depth of the strainer cannot be optimized for differing water levels within the container. Therefore, a single serving beverage infuser that does not block the beverage container opening, allows a user to taste the beverage without removing the infuser, and is adjustable such that the depth of the strainer can be optimized for differing water levels is desirable.

The tea bag addresses certain disadvantages of the aforementioned straining equipment but, it too, has numerous disadvantages. A typical tea bag comprises a porous sealed bag containing a single charge of infusing material, e.g. crushed tea leaves. The porous sealed bag is commonly made of bleached paper, bleached cheese cloth, polylactic acid (PLA), or nylon fabrics derived from genetically modified corn. Due to the relatively small pore size of a typical tea bag, once the pores are saturated with water the resulting surface tension creates a barrier between the mediums of water and air. Initially, the surface tension seals an amount of air within the tea bag which causes the bag to float and slows the infusing process. Once the bag is submerged the relatively small pore size causes an amount of drag and/or resistance on the fluid and prevents the free and open flow of water through the infusing medium, e.g. crushed tea leaves, which further slows the process. Beverage consumers often attempt to induce the flow of hot water through the charge of infusing material by repeating the steps of dunking the bag into the water, allowing the bag to become saturated, removing the bag from the water, and allowing the liquid to drain from the bag. Unfortunately, the surface tension effect which initially sealed air in the tea bag causing it to float now seals liquid in the tea bag and prevents it from draining This again slows the process of infusing the beverage and, because many beverage consumers, do not wish to wait for the bag to drain completely an amount of infused liquid will be discarded with the tea bag resulting in excess waste of the tea product and excess dripping.

Due to the impeded flow of water through the tea bag material, it is typical for tea bags to contain tea fannings because without freely flowing water the time required to infuse a beverage using higher quality tea leaves is undesirable. Fannings are small pieces of tea remaining after higher grade tea leaves have been gathered, and fannings with very small particles are known as tea dusts. It is these tea dusts that are most commonly used in tea bags. These low quality tea dusts quickly color the liquid being infused but fail to quickly transfer flavors into the beverage. Moreover, the quality of tea fannings and dusts quickly degrades resulting in tea bags having a reduced shelf life when compared to higher quality teas. Therefore, a single serving beverage infuser that readily sinks into water, allows for water to freely flow through the infuser when submerged, and quickly drains water therefrom when removed from the water is desirable.

Other disadvantages of the tea bag include that it typically must be discarded after only a single use and that it is available in only limited pre-manufactured flavors. Many infused beverage drinkers are deeply conscious of environmental issues and prefer to use products that are fully biodegradable. In order to reduce economic costs of production most tea bag manufacturers use at least some non-biodegradable materials, e.g. most tea bags comprise a string attached to bag with at least on metal staple and many tea bags are wholly made of non-biodegradable nylon. Additionally, because large production “runs,” often in the tens or hundreds of thousands of units, are required to minimize costs associated with changing and tracking production materials it is unfeasible for as wide an array of tea flavors as is supported by market demand to be produced. Therefore, a single serving beverage infuser that is reusable, is fully biodegradable, and allows for a user to customize flavors by selecting the charge of infusing material from the widely available selection bulk loose leaf teas is desirable.

U.S. Pat. Appl. Pub. No. U.S. 2011/0183042 by applicant Teng, dated Jul. 28, 2011, and fully incorporated by reference herein, discloses a tea infuser that comprises a top member and a bottom member set to slidably mate with each other forming open, closed and compressed positions. An object of the tea infuser disclosed by Teng is to alleviate the waste and dripping associated with discarding a tea bag and its charge of infusing material in a saturated state. In order to function properly, the design of the of the tea infuser disclosed by Teng requires the selection and use of an unyielding material, e.g. metal or hard plastic, because the tea infuser is required to withstand certain forces that are applied during the compression of saturated charge of infusing material. Accordingly, selection of a readily biodegradable material is unfeasible for use in this product. An additional drawback of the Teng infuser is that many infused beverage drinkers refuse to use metal infusers because the resulting beverage possesses a palpable and undesirable metallic taste.

For many infused beverage drinkers, bamboo is the optimal material for an infuser because it is reusable, biodegradable, and after several uses (or if pretreated using the method disclosed herein) leaves no palpable and/or undesirable taste in the infused beverage. Since, a typical bamboo infuser will, for at least the first several uses until it is “worn in,” leave a slightly bitter taste from the wood fibers in the beverage the result being that the taste of the final infused beverage is not purely the product of the charge of infusing material chosen. Therefore, a method of pretreating the natural bamboo wood fibers to remove any substances capable of altering the taste of an infused beverage prior to the beverage infuser's first use is desirable.

Each of the various attempts at improving the available single serving beverage infusers suffer from any or all of: requiring a user to manually hold the charge of infusing material in contact with the hot water; failing to facilitate the periodic tasting of the beverage without removing the infuser; causing excessive dripping due to having to remove the infuser to taste the beverage or failing to readily drain once removed from the beverage, not being capable of depth adjustment to ensure that the charge of infusing material remains in contact with the beverage as the water level changes, not being reusable, not being feasibly constructed from biodegradable materials, and leaving a palpable and undesirable taste in the beverage.

Accordingly, this application discloses a single serving beverage infuser and method of pre-treating the same to remove any substances capable of altering the taste of an infused beverage prior to the beverage infuser's first use. The single serving beverage infuser disclosed herein is self-supporting, can be adjustably positioned corresponding to water depth, allows for the beverage to be easily consumed even with the infuser in position, is insusceptible to performance detriments resulting from surface tension, is preferably constructed from fully biodegradable materials, and has no independent effect on the taste of the final infused beverage product.

### SUMMARY

A single serving beverage infuser and method of pretreating the same is disclosed herein. In one embodiment, the beverage infuser comprises a receptacle for receiving a charge of beverage infusing material and a tether attached to a top end of the receptacle for suspending the receptacle, the tether being configured such that at least a portion of the tether is capable of hooking onto at least a portion of a beverage container wherein a beverage is to be infused regardless of the size or shape of the container. Preferably, the infuser is made from natural bamboo fibers and, accordingly, the method of pretreating the beverage infuser removes the undesirable woody and bitter taste present in the bamboo fibers.

### BRIEF DESCRIPTION OF THE DRAWINGS

Embodiments of the beverage infuser are described in detail below with reference to the following drawings.

FIG. 1 is an isometric view, in accordance with an embodiment of the beverage infuser, showing a single serving beverage infuser in a self-supporting position within a beverage container.

FIG. 2 is a side view, in accordance with an embodiment of the beverage infuser, showing a receptacle for receiving a charge of beverage infusing material and a tether for suspending the receptacle.

FIG. 3 is a bottom view, in accordance with an embodiment of the beverage infuser, showing a closed bottom end of the receptacle.

FIG. 4 is a top view, in accordance with an embodiment of the beverage infuser, showing a partially open top end of the receptacle such that a charge of beverage infusing material may be inserted into the receptacle through the top end.

FIGS. 5-6 are illustrations of beverage infusers currently within the public domain.

### DETAILED DESCRIPTION

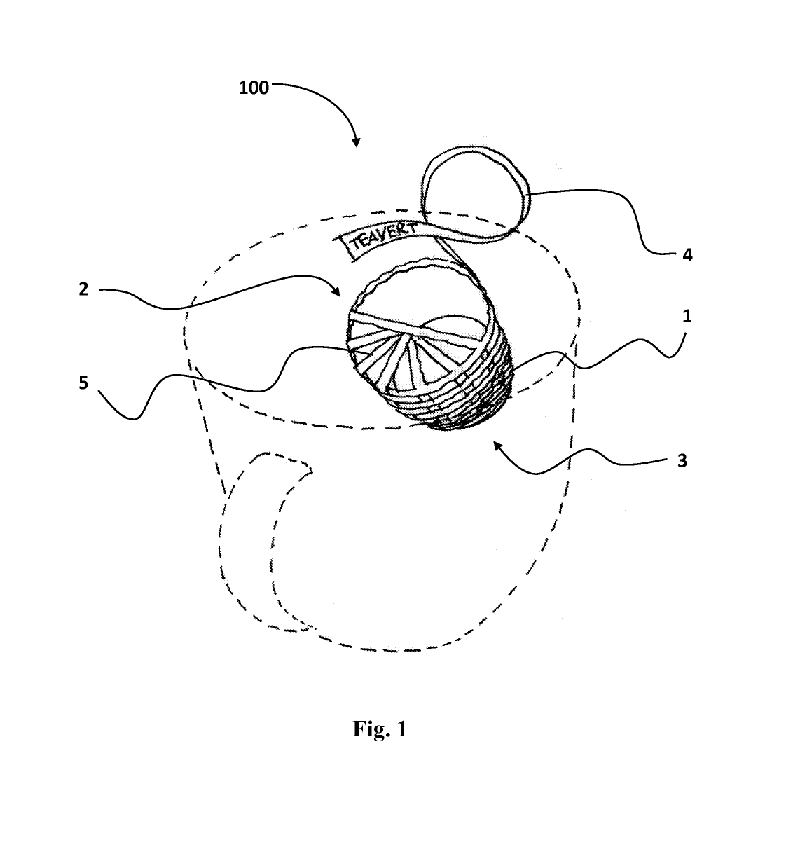

A single serving beverage infuser and method of pretreating the same is disclosed herein. Specific details of certain embodiments of the single serving beverage infuser method of pretreating the same are set forth in the following description and in FIGS. 1-4 to provide a thorough understanding of such embodiments. The present single serving beverage infuser and method of pretreating the same may have additional embodiments, may be practiced without one or more of the details described for any particular described embodiment, or may have any detail described for one particular embodiment practiced with any other detail described for another embodiment.

FIG. 1 is an isometric view, in accordance with an embodiment of the beverage infuser 100, showing a single serving beverage infuser in a self-supporting position within a beverage container. In certain embodiments, the beverage infuser 100 comprises a receptacle 1 having a top end 2 and a bottom end 3. Preferably, the receptacle 1 comprises biodegradable materials which are durable enough withstand numerous use cycles. For example, bamboo is a preferable choice of materials for the receptacle 1 due to it being biodegradable, fast growing and therefore economical and capable of withstanding numerous use cycles. Additionally, bamboo fibers are easily woven together to create durable and lasting shapes. Other materials may also be used for the receptacle, e.g. the receptacle may comprise wood, hemp, grasses of any type, graminoids, or any combination thereof. The foregoing list of possible material choices is for illustrative purposes only and is not intended to limit the scope of the beverage infuser. The receptacle 1 is at least partially permeable by water such that liquid may freely flow through the walls thereof. Preferably, the size of the pores on the receptacle are sufficiently small in size that a charge of beverage infusing material, e.g. crushed loose leaf tea leaves, cannot escape from the receptacle 1 through the pores but also sufficiently large that any surface tension formed on the receptacle has a negligible effect on the flow of water. In the illustrated embodiment, the receptacle 1 is constructed of woven natural bamboo fibers and the pores comprise the small openings within the weave. As used herein, a pore is any one of many small openings in a material, e.g. the receptacle 1, that contribute to the materials porosity and/or permeability. In some embodiments, the receptacle 1 is sized such that when filled with beverage infusing material it contains a single serving of beverage infusing material. This relieves the user from having to premeasure the beverage infusing material.

In some embodiments, the infuser further comprises a tether 4 configured for suspending the receptacle 1. It is an object of the single serving beverage infuser 100 disclosed herein to be configured for supporting itself within a beverage container at an appropriate depth associated with the current water level within the beverage container. Preferably, the tether 4 is semi-rigid such that externally applied forces, e.g. forces applied by a person, can easily bend the tether and/or wrap it around or over either the rim of the container or a handle on the container. It has been discovered that dried natural bamboo fibers possess optimal semi-rigid structural characteristics for the tether 4 because the fibers are sufficiently flexible such that they may be bent and/or formed to wrap around one or more portions of a beverage container, e.g. a rim and/or a handle, yet the fibers are also sufficiently rigid or unyielding that the weight of the receptacle alone will not deform the tether 4. The result of the semi-rigid structural characteristics is that the tether 4 can be easily formed to suspend the receptacle 1 within the beverage container at whatever depth is desired. While bamboo has been disclosed as a preferable material for the tether 4, this description is not intended to limit the scope of the beverage infuser 100. In some embodiments, the tether 4 is curved in shape. In some embodiments the tether is generally helical in shape; as used herein, helical is used generally to denote that the tether is curved but resemble a helix. It does not mean that the tether is restricted to a shape being defined by the mathematical formula for a helix. Preferably, the tether 4 is helical in shape with a pitch of roughly 0.125 inch to 0.25 inch because such a shape and pitch enables the user to easily suspend the receptacle 1 at discreet depth intervals roughly corresponding to the pitch. As used herein, a tether is any element that anchors a movable object, e.g. the receptacle 1, to a reference point which may be either fixed or moving, e.g. a beverage container.

In a preferred embodiment, the receptacle 1 comprises a cover 5 over roughly one half of an opening at the top end 2. Such a cover 5 is preferable because it assists in retaining the charge of beverage infusing material during use. It is also preferable that the tether 4 is attached to the top end 2 at a location opposite the cover 5 such that that when the receptacle 1 is suspended from the tether 4 the receptacle 1 tilts and the opening of the receptacle comes to rest at the highest point of the receptacle 1. It has been found that such an orientation reduces the spillage of beverage infusing material from the receptacle 1. Such an embodiment is depicted in FIG. 1.

FIG. 2 is a side view, in accordance with an embodiment of the beverage infuser, showing a receptacle for receiving a charge of beverage infusing material and a tether for suspending the receptacle. In the illustrated embodiment, the bottom end 3 of the receptacle is generally planar such that the beverage infuser is capable of being stood upright on a flat surface, e.g. a table, because this enables a user to fill the receptacle 1 with a charge of beverage infusing material and then stand the infuser upright such that the charge is not spilt through the top end 2 of the receptacle. In different embodiments, the bottom end 3 of the receptacle is rounded in shape. For example, the bottom end 3 may be generally the shape of an end of a U.S. Large Grade AA chicken egg. The aforementioned shapes are for illustrating purposes only and are not intended to limit the scope of the beverage infuser.

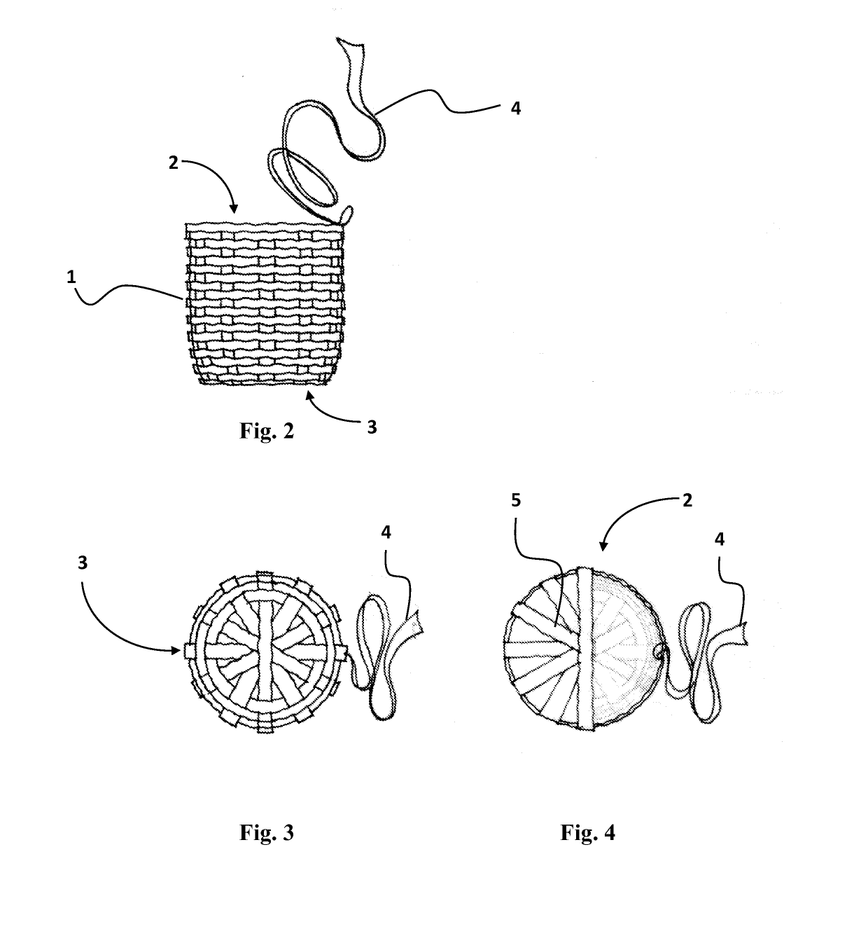

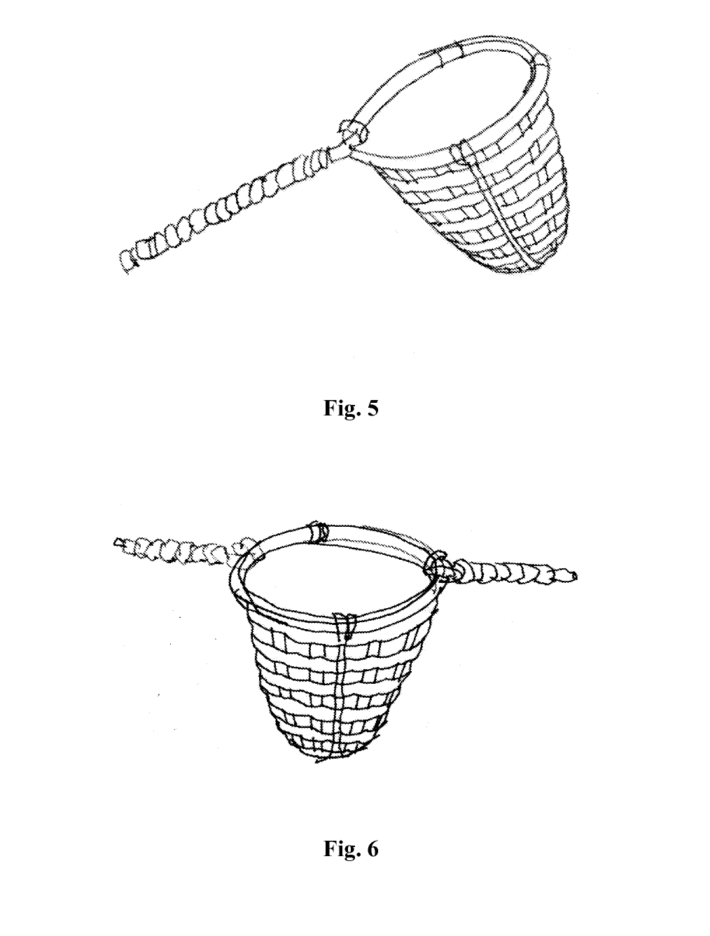

FIG. 3 is a bottom view, in accordance with an embodiment of the beverage infuser, showing a closed bottom end 3 of the receptacle. Preferably, the closed bottom end 3 of the receptacle is at least as permeable as any other portion of the receptacle 1 because such a configuration will allow for expedient draining of infused water from the receptacle. A permeable bottom end is preferable because many infused beverage drinkers tend to repeatedly dunk and remove an infuser from water as an attempt to speed the infusing process. FIG. 4 is a top view, in accordance with an embodiment of the beverage infuser, showing a partially open top end of the receptacle such that a charge of beverage infusing material may be inserted into the receptacle through the top end. In the illustrated embodiment, the receptacle 1 comprises a cover 5 over roughly one half of an opening at the top end 2. Such a cover 5 is preferable because it assists in retaining the charge of beverage infusing material during use. In some embodiments, at least a portion of the cover is hingedly connected such that the cover can be positioned for removing a charge of beverage infusing material, depositing a charge of beverage infusing material, cleaning the inner region of the receptacle, or any combination thereof. In a preferred embodiment, the cover is hingedly connected and is capable of covering substantially the entire opening at the top end 2 because this configuration allows for the entire beverage infuser 100 to be submerged in liquid without the charge escaping from the receptacle 1.

It is preferable that the single serving beverage infuser comprises a natural and biodegradable material such that it is readily disposable, e.g. it can be placed in standard garbage or composted. Moreover, it is intended for the single serving beverage infuser to be reusable if the user so desires. It has been found that bamboo is the ideal material to achieve these properties; however, other materials obviously may be chosen. After roughly two weeks of age, bamboo begins to take on a woody and bitter flavor. This flavor is highly undesirable and unsatisfying and will leach into liquids that the plant comes in contact with. However, after the plant has substantially leached this flavor it can be submerged in even boiling water without leaving any detectable taste. Therefore, a method of removing this taste prior to a first use of the beverage infuser is desirable and disclosed herein. The method also removes oils, e.g. human oils deposited on the infuser during handling, and many other substances that might be present as a result of manufacturing the single serving beverage infuser. While the reason for utilizing the method for bamboo has been described, it should be noted that many other materials suitable for constructing the beverage infuser may also benefit from the method disclosed herein. For example, most wood products and grasses also initially possess undesirable flavors.

In the method, the infuser is submerged in a solution designed for extracting unwanted flavors and/or smells from the infuser. It has been discovered that the solution preferably comprises water, citric acid, assam black tea, or any combination thereof. More specifically, the solution preferably consists of 1 liter (L) of water, 0.06 L lemon juice, and 1 tablespoon assam black tea. Alternatively, the solution may comprise a mixture of water and vinegar. Vinegar has the desirable properties of killing germs, dissolving greases, being inexpensive, and leaving no taste or odor once it has been allowed to evaporate. The effectiveness of the method and rate at which unwanted flavors and smells are removed from the beverage infuser can be increased be increasing the temperature of the solution, e.g. boiling the solution. Preferably, the beverage infuser remains submerged in the solution for at least 30 minutes prior to being removed. Upon removal from the solution, the infuser is at least partially dried. The steps of the method may be repeated for numerous cycles until substantially all undesirable and detectable flavors and/or smells have been removed. In a preferred embodiment of the method, the infuser is initially boiled in a solution of 1 liter (L) of water, 0.06 L lemon juice, and 1 tablespoon assam black tea, and subsequently allowed to dry and then boiled in pure water to remove any remaining flavors, e.g. trace flavors of lemon juice and/or assam tea. The specific description of the solution designed for extracting unwanted flavors and/or smells from the infuser is for illustrative purposes only and is not to be construed as limiting.

It is intended for the infuser and the method of pretreating the same to be combined so that the infuser may be pretreated and then preloaded with a charge of beverage infusing material prior to distribution. Although the infuser and method are intended to be combined, it is within the scope of the infuser and method to be practiced independently from one another.

While preferred and alternate embodiments have been illustrated and described, as noted above, many changes can be made without departing from the spirit and scope of the single serving beverage infuser and method of pretreating the same. Accordingly, the scope of the single serving beverage infuser and method of pretreating the same is not limited by the disclosure of these preferred and alternate embodiments. Instead, the scope of the single serving beverage infuser and method of pretreating the same should be determined entirely by reference to the claims that follow.

What is claimed is:

1. An infuser for making beverages comprising:
a receptacle for receiving a charge of beverage infusing material, the receptacle having a top end that is at least partially open and a bottom end that is closed such that the receptacle is configured for receiving the charge of beverage infusing material through the top end, the receptacle being at least partially permeable such that liquid is permitted to freely flow between the regions lying inside and outside of the receptacle;
and a tether attached to the top end of the receptacle for suspending the receptacle, the tether being configured such that at least a portion of the tether is capable of hooking onto at least a portion of a beverage container wherein a beverage is to be infused.

2. The infuser of claim 1, wherein the receptacle for receiving a charge of beverage infusing material further comprises a cover over at least a portion of the top end of the receptacle, such that the cover prevents the charge of beverage infusing material from escaping from the inner region of the receptacle.

3. The infuser of claim 2, further comprising means for hingedly connecting at least a portion of the cover to the receptacle, such that the cover can be positioned for removing a charge of beverage infusing material, depositing a charge of beverage infusing material, cleaning the inner region of the receptacle, or any combination thereof.

4. The infuser of claim 1, wherein the receptacle for receiving a charge of beverage infusing material further comprises at least one of natural bamboo fibers, wood, hemp, grasses, graminoids, or any combination thereof.

5. The infuser of claim 1, wherein the tether attached to the top end of the receptacle for suspending the receptacle is at least partially helical in shape such that at least a portion of the tether is capable of hooking onto at least a portion of a beverage container wherein a beverage is to be infused.

6. The infuser of claim 1, wherein the tether attached to the top end of the receptacle for suspending the receptacle further comprises at least one of natural bamboo fibers, wood, hemp, grasses, graminoids, or any combination thereof.

7. A method of pretreating the infuser of claim 1, comprising the steps of:
(a) obtaining a solution for pretreating the infuser;
(b) submerging the infuser in the solution;
(c) removing the infuser from the solution after a predetermined amount of time; and
(d) at least partially drying the infuser.

8. A method according to claim 7, wherein the steps of submerging the infuser in the solution, removing the infuser from the solution after a predetermined amount of time, and at least partially drying the infuser are repeated, so that the amount of detectable taste the infuser may deposit into a beverage is minimized.

9. A method according to claim 7, wherein the steps of obtaining a solution for pretreating the infuser, submerging the infuser in the solution, removing the infuser from the solution after a predetermined amount of time, and at least partially drying the infuser are repeated; and wherein the obtained solution contains a higher percentage of water with each subsequent cycle, so that the amount of detectable taste the infuser may deposit into a beverage is minimized.
